(19) United States
(12) Patent Application Publication
(10) Pub. No.: US 2011/0210912 A1
(43) Pub. Date: Sep. 1, 2011

(54) METHOD AND APPARATUS FOR CONTROLLING THE BRIGHTNESS OF AN LCD BACKLIGHT

(75) Inventors: Keith Noel Jenkins, Gloucestershire (GB); Gary Bryan Wordsworth, Gloucestershire (GB)

(73) Assignee: ITI SCOTLAND LIMITED, Glasgow (GB)

(21) Appl. No.: 13/128,494

(22) PCT Filed: Nov. 10, 2009
(86) PCT No.: PCT/GB09/51500

§ 371 Date: May 10, 2011

(30) Foreign Application Priority Data
Nov. 10, 2008 (GB) 0820540.3

(51) Int. Cl. G09G 3/36

(52) U.S. Cl. 345/102

(57) ABSTRACT

The brightness of a LCD backlight, comprising a plurality of LEDs or LED chains (221_{—}1 to 221_{—}n), is controlled by a processor (203) for calculating the number of LEDs of a plurality of LEDs to be illuminated for a determined brightness and selecting the calculated number of LEDs or LED chains to form a spatial distribution pattern; and drivers (219_{—}1 to 219_{—}n) for illuminating the calculated number of LEDs in a random or pseudo-random sequence.

### FIELD OF THE INVENTION

The present invention relates to method and apparatus for controlling the brightness of a LCD backlight. In particular, it relates to controlling the brightness of an LED backlight for a LCD.

### BACKGROUND OF THE INVENTION

Many techniques have been developed to control the brightness of an LED backlight in a LCD. Some LED backlights use white LEDs while others use a combination of coloured LEDs to produce the required white light. In the latter case, the resultant colour is very dependant on the relative brightness of the LEDs and the relationship between the forward current of a LED and its brightness which is not precisely linear. The precise colour of a white LED can also change with its forward current. For this reason the brightness of LED backlights is normally controlled by pulsing the LED on and off at a single current and adjusting the proportion of the time that they are switched on. The pulse rate is chosen so that the response of the human eye averages the perceived brightness and the backlight does not flicker.

Pulse Width Modulation (PWM) is commonly used to control the brightness of LED backlights for such displays. FIG. 1 illustrates a simple schematic of a simple PWM waveform generator employed for brightness control. The PWM waveform generator 101 comprises a brightness controller 103 connected to a first input terminal 105 of a comparator 107. The PWM waveform generator 101 further comprises a sawtooth generator 109 connected to a second input terminal 111 of the comparator 107. The PWM waveform generator 101 further comprises an output terminal 113 which is connected to the output terminal 115 of the comparator 107.

The output terminal 113 of the PWM waveform generator 101 is connected to the input of an LED driver 117. The output of the LED driver 117 is connected to at least one LED chain comprising a plurality of LEDs 119.

In operation, the brightness controller 103 provided by user input, for example, outputs the brightness level. The output brightness level is compared with a sawtooth waveform, output by the sawtooth generator 109, by the comparator 107. The resulting output of the comparator 107 is a pulse waveform in which the width of the pulse is varied in accordance with any variation in the determined brightness level. The pulse waveform is then used by the LED driver 117 to turn the LEDs 119 on or off by a period determined by the pulse width and hence dependent on the brightness level.

Examples of known drive circuits for LCD backlights using a PWM waveform are disclosed by US Patent Application Nos. 2007/236445 and 2004/0145560.

As described above with reference to FIG. 1, prior art techniques switch the LEDs on and off altering the ratio of on and off time to achieve the required average brightness (as perceived by a viewer). However, in such known systems, interaction (intermodulation) of the video signal being displayed and the PWM signal occurs. This results in motion artefacts, flicker and moving or static patterning and Electro Magnetic Interference (EMI) providing undesirable effects to the display.

### SUMMARY OF THE INVENTION

The present invention seeks to provide brightness control of an LCD backlight which reduces motion artefacts, patterning, flicker and EMI.

This is achieved according to a first aspect by a method for controlling the brightness of a LCD backlight, the LCD backlight comprising a plurality of LEDs, the method comprising the steps: determining the brightness required for a LCD backlight; calculating the number of LEDs of a plurality of LEDs to be illuminated for the determined brightness; selecting the calculated number of LEDs of the plurality of LEDs to form a spatial distribution pattern of the calculated number of LEDs across the plurality of LEDs; and illuminating the selected, calculated number of LEDs.

This is also achieved by a second aspect by apparatus for controlling the brightness of a LCD backlight, the LCD backlight comprising a plurality of LEDs, the apparatus comprising: an input for receiving a determined brightness required for a LCD backlight; a processor for calculating the number of LEDs of a plurality of LEDs to be illuminated for the determined brightness and selecting the calculated number of LEDs of the plurality of LEDs to form a spatial distribution pattern of the calculated number of LEDs across the plurality of LEDs; and a driver for illuminating the selected, calculated number of LEDs.

The spatial distribution pattern of the illuminated LEDs reduces intermodulation of the video and drive signals, making motion artefacts etc less visible than produced by previous solutions. Furthermore a constant number of LEDs are “on” for a constant brightness resulting in a constant power supply current.

Reference to LED above is to an individual LED or a LED chain.

In an embodiment, the selected, calculated number of LEDs may be changed to form a different spatial distribution pattern of the calculated number of LEDs with each of a plurality of time intervals.

In this way, a spatial variation in the LED drive is provided. The intermodulation of the video signal and the drive signal for the display is further reduced, improving picture quality, reducing motion artefacts, patterning and flicker. Further, the spatial variation reduces electromagnetic interference with other parts of the display for example the liquid crystal drive signals as well as reducing electromagnetic inference with other equipment. Further, the implementation can be simplified using reduced components and hence reducing requirements to screen the LED backlight wiring (circuit board tracking).

The time interval may be determined to ensure no visible LED flicker and may be variable. The calculated number of LEDs may be selected according to a recorded or synthesised incoherent sequence to form the spatial distribution pattern, for example, the spatial distribution pattern may be randomly or pseedo-randomly formed. As a result making it less patterned and more noise like and thus further reducing intermodulation of the video and drive signals, making motion artefacts etc even less visible.

The plurality of LEDs may be arranged in a one-dimensional linear array of LED chains, each LED chain comprising at least one LED, or alternatively, arranged in a two-dimensional array of LED chains, each LED chain comprising at least one LED. Further longer LED chains may be feasible due to reduced emissions for a given drive voltage. Further there is a reduced risk of visible interaction with other ambient frequencies for example lighting, other displays etc.

The calculated number of LEDs may be illuminated by pulsing the LEDs on and off at a random or pseudo-random rate, that is, combining with temporal spread spectrum techniques to give better performance.

### BRIEF DESCRIPTION OF DRAWINGS

For a more complete understanding of the present invention, reference is made to the following description in conjunction with the accompanying drawings, in which:

FIG. 1 is a simplified schematic of a known technique of controlling brightness of LEDs of a LCD backlight;

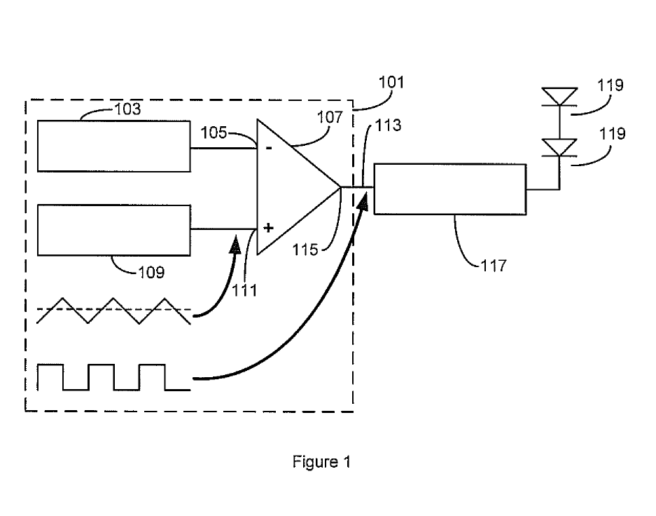

FIG. 2 is a simplified schematic of apparatus according to an embodiment of the present invention;

FIG. 3 is a flow chart of the processes of the circuit of FIG. 2; and

FIG. 4 is a simplified schematic of a circuit according to another embodiment of the present invention.

### DETAILED DESCRIPTION OF AN EMBODIMENT OF THE INVENTION

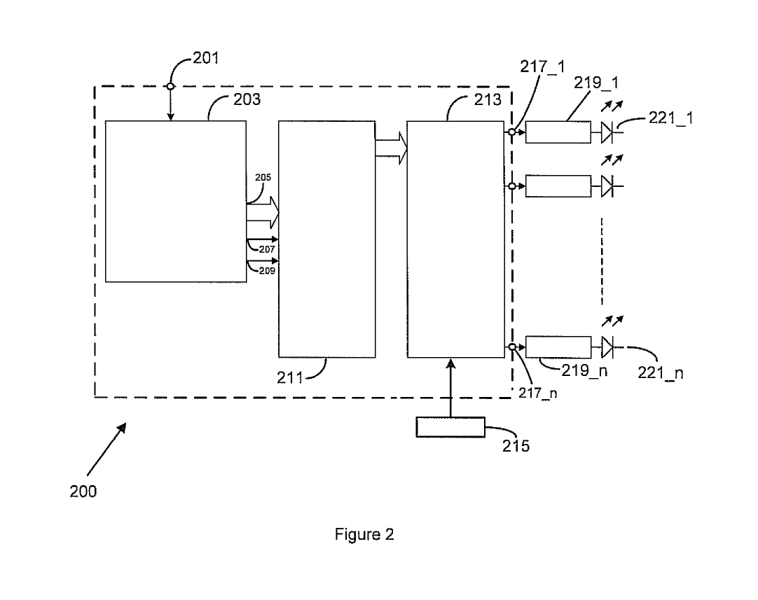

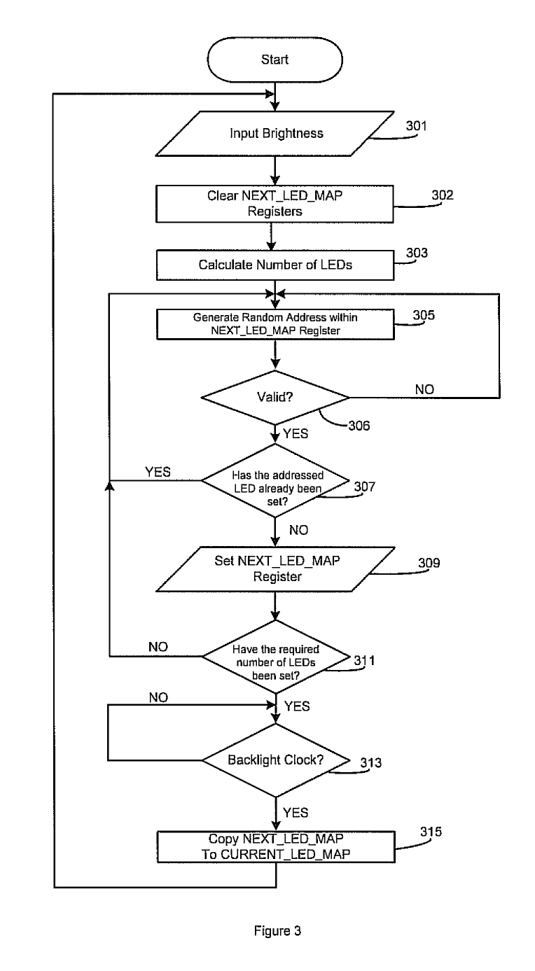

An embodiment of the present invention will now be described with reference to FIGS. 2 and 3.

The apparatus 200 comprises an input terminal 201 connected to an input of a microprocessor 203. The microprocessor 203 may be a microprocessor that controls the rest of the display unit that the backlight unit forms part of (not shown here) or it may be dedicated to the functions described below with reference to FIG. 3.

The microprocessor 203 comprises an address output port 205, a SET output 207 and a CLEAR_ALL output 209. The address output port 205, the SET output 207 and the CLEAR_ALL output 209 of the microprocessor 203 are connected to respective inputs of a NEXT_LED_MAP register 211. The output port of the NEXT_LED_MAP register 211 is connected to the respective input of a CURRENT_LED_MAP register 213. The CURRENT_LED_MAP register 213 is also connected to a backlight clock 215. The NEXT_LED_MAP register 211 and the CURRENT_LED_MAP register 213 comprise a plurality of parallel registers (not shown). Each register of the NEXT_LED_MAP register 211 is connected to a respective register of the CURRENT_LED_MAP register 213. Each register of the CURRENT_LED_MAP register 213 has a respective output which is connected to respective output terminals 217_1 to 217_{—}n of the apparatus 200. Each of the output terminals 217_1 to 217_{—}n of the control circuit 200 is connected to a respective driver circuit 219_1 to 219_{—}n for a respective LED or LED chain 221_1 to 221_{—}n. The LED chains may be arranged in a one-dimensional linear array or in a two-dimensional array.

Operation of the circuit of FIG. 2 will be described in more detail with reference to FIG. 3. The required brightness level is communicated to the microprocessor 203 on the input terminal 201 either via user control and interface electronics or from another microprocessor that controls the whole of the display, step 301. The microprocessor 203 clears the NEXT_LED_MAP register 211 on the CLEAR_ALL output 209, step 302. The microprocessor 203 then calculates how many of the LEDs or LED chains need to be illuminated for the next cycle of the backlight clock 215 to achieve the required brightness level which has been input on the input terminal 201, step 303. The microprocessor 203 uses an incoherent sequence to choose an address, step 305. Each valid address represents an LED or LED chain that will be illuminated. The incoherent sequence may be synthesised dynamically or alternatively a predetermined recorded incoherent sequence may be utilised. The incoherent sequence may comprise a random or pseudo random sequence. In step 306 the generated address is checked that it is within the range of the NEXT_LED_MAP register 211 and is therefore a valid address. If the address is not valid then another address is generated and checked for validity (steps 305, 306 are repeated). Once a valid address is generated, in step 307 the valid address is checked to establish if it has been set previously by the incoherent sequence, if the address is a duplicate then another address is generated and once more validated.

The microprocessor 203 then sets the NEXT_LED_MAP register 211 corresponding to each valid address on the SET output 207 and the address output port 205 in step 309. Addresses are generated until the required number of LEDs or LED chains originally calculated by the microprocessor to achieve the required brightness level has been reached, i.e. enough LEDs or LED chains have been set, step 311.

On the next cycle of the backlight clock 215, the CURRENT_LED_MAP register 213 adopts the values of the NEXT_LED_MAP register 211, steps 313 and 315.

The current address values within the CURRENT_LED_MAP register 213 are then used to activate and drive the appropriate LEDs or LED chains 221_1 to 221_{—}n via the drivers 219_1 to 219_{—}n. As a result, the brightness level is achieved by the number of illuminated LEDs or LED chains. The addressing and hence the spatial spread generated by the incoherent sequence enables the system to benefit from a spread spatial frequency spectrum making correlations of coherent intermodulation products from an image less likely, as a result reducing motion artefacts, patterning and flicker.

The embodiment operates on a time interval basis. The time interval period is chosen to be fast enough for the eye to integrate any discrete “on” and “off” periods to give the perception of a constant brightness such that no visible LED flicker is perceived.

In each time interval the selected calculated number of LEDs (or LED chains) in the backlight are turned “on” such that the proportion turned on in relation to the total represents the proportion of full brightness that is required. The spatial distribution pattern, i.e. the addresses generated in step 305 may be varied within each time intervals.

Calculations such as the proportion of LEDs required to achieve a perceived brightness or a variation of the brightness across the screen to account for variations of ambient lighting across the screen, may be modified by a simple look up table or other means to address any non-linear response of the eye.

Therefore the number of LEDs to turn “on” are computed and which of the LEDs (or chains of LEDs) are to be turned on is made by an incoherent sequence which is chosen from a predetermined recorded library of sequences or synthesised to have the desired spread spectrum and other characterisitics. For example a random or pseudo random sequence may be used. The sequence used for the selection of LEDs may be designed to optimise the performance to reduce low frequency flicker or so that a more continuous current is drawn from the power supply.

This process gives a random spatial distribution of illuminated LEDs in each time slice, ensuring that the spatial frequency of the backlight is spread.

It can be seen that the temporal distribution of “on” periods for any one LED (or chain of LEDs) is also likely to have a temporal spectrum that is spread (it is on when it is chosen at random to be part of that cycles group of illuminated LEDs). The method described above may be combined with a method of temporal spread as disclosed for example in co-pending UK application nos. 0820539.5 and 0919551.2 to increase the number of possible brightness levels beyond the number of LEDs (or chains of LEDs)

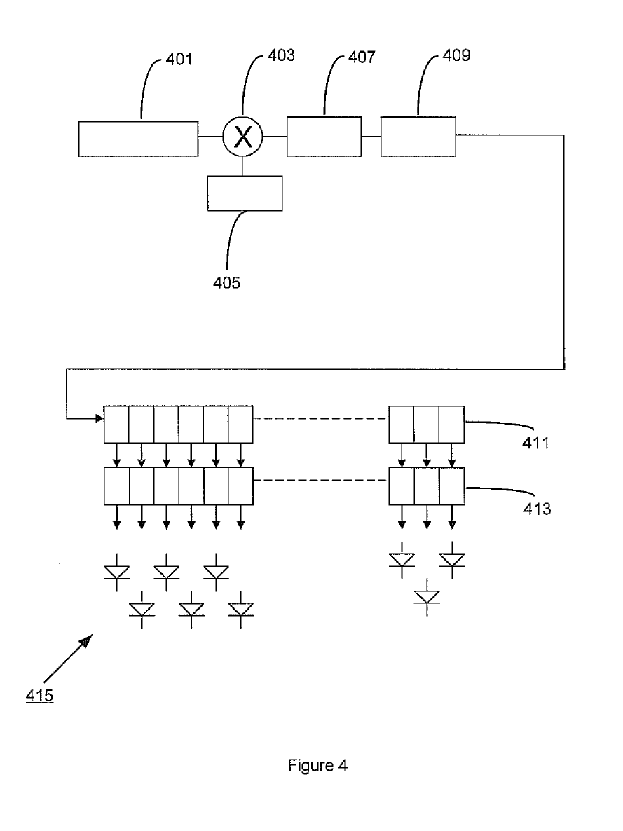

FIG. 4 shows a block diagram of an LED backlight driver according to another embodiment that embodies both temporal and spatial spread spectrum characteristics.

The apparatus comprises a pseudo random generator 401 of values 0 to 2. The output of the pseudo random generator 401 is connected to a first input terminal of a modulator 403, such as a multiplier. A second input terminal of the modulator 403 is connected to a brightness control 405. The output of the modulator is connected to the input of a FIR filter 407. The output of the filter 407 is connected to the input of a delta sigma modulator 409. The output of the delta sigma modulator 409 is connected to a shift register 411. The output of the shift register 411 is connected to the input of a double buffer register 413. The output of the double buffer register 413 is connected to driver and LED chains 415. The frequency of the operating clock of the shift register 411 is that of the backlight clock multiplied by the number of LED chains. The frequency of the operating clock of the double buffer register 413 is that of the backlight clock.

The pseudo random generator 401 outputs a multibit representation of a uniformly distributed pseudo random signal. The randomising signal is a multilevel signal represented by a multibit code that has a uniform, pseudo random, probability distribution. The pseudo random signal need not be designed or synthesised by a random process but can be designed to optimise its spread spectrum characteristics, for example, the signal can be synthesised to have a spectrum comprising many closely spaced low level harmonics but without any very low frequency harmonics that might themselves cause visible flicker. This can be done by many methods well know to experts in signal processing for example summing multiple sinusoids or by synthesising the frequency domain signal and Fourier transforming to obtain the time domain. The resultant time domain signal can be stored in a memory and read out, it does not have to be synthesised in real time. The spread spectrum is modulated by a dc or low frequency content signal representing the brightness level. The multiplied signal is filtered by the FIR filter 407. The FIR filter 407 is optional and further optimises the spectral characteristics of the modulation. This signal is then modulated by the delta sigma modulator 409 to output a spread spectrum signal as described in more detail in co-pending UK application nos. 0820539.5 and 0919551.2

The spread spectrum signal is clocked into the first shift register 411. The first and second shift registers comprise a number of registers equal to the number of LEDs or LED chains to be driven. The outputs of the first register are latched into the second register on a backlight clock trigger and are copied into the double buffer register 413 which in turn determines the state of the LED chains until the next backlight clock.

In another embodiment, coherence is further reduced, for example, for N LEDs and LED chains, the first register is clocked N times between each clock of the second register. Alternatively, the LEDs or LED chains are not connected to the registers in their spatial order to further reduce coherence.

This embodiment has the benefit of spatial de-correlation in common with the first embodiment mentioned above and also can achieve the fine control of brightness.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

1. A method for controlling the brightness of a LCD backlight, said LCD backlight comprising a plurality of LEDs, the method comprising the steps:
determining the brightness required for a LCD backlight;
calculating the number of LEDs of a plurality of LEDs to be illuminated for said determined brightness;
selecting said calculated number of LEDs of said plurality of LEDs to form a spatial distribution pattern of said calculated number of LEDs across said plurality of LEDs; and
illuminating said selected, calculated number of LEDs.

2. A method according to claim 1, wherein the method further comprises the steps of:
changing said selected, calculated number of LEDs to form a different spatial distribution pattern of said calculated number of LEDs within each of a plurality of time intervals.

3. A method according to claim 2, wherein said time interval is determined to ensure no visible LED flicker.

4. A method according to claim 2 or 3, wherein said time interval is variable.

5. A method according to claim 1, wherein the step of selecting said calculated number of LEDs comprising the step of:
selecting said calculated number of LEDs according to a recorded or synthesised incoherent sequence to form the spatial distribution pattern.

6. A method according to claim 5, wherein the method further comprises the step of:
retrieving a recorded incoherent sequence for selecting said calculated number of LEDs.

7. A method according to claim 5, wherein the method further comprises the step of:
synthesising an incoherent sequence for selecting said calculated number of LEDs.

8. A method according to any one of the preceding claims, wherein said plurality of LEDs are arranged in a one-dimensional linear array of LED chains, each LED chain comprising at least one LED.

9. A method according to any one of claims 1 to 7, wherein said plurality of LEDs are arranged in a two-dimensional array of LED chains, each LED chain comprising at least one LED.

10. A method according to any one of the preceding claims, wherein the step of illuminating said selected, calculated number of LEDs further comprises the step of:
pulsing said selected, calculated number of LEDs on and off at a random or pseudo-random rate.

11. A computer program product comprising a plurality of program code portions for carrying out the method according to any one of the preceding claims.

12. Apparatus for controlling the brightness of a LCD backlight, said LCD backlight comprising a plurality of LEDs, the apparatus comprising:
an input for receiving a determined brightness required for a LCD backlight;
a processor for calculating the number of LEDs of a plurality of LEDs to be illuminated for said determined brightness and selecting said calculated number of LEDs of said plurality of LEDs to form a spatial distribution pattern of said calculated number of LEDs across said plurality of LEDs; and
a driver for illuminating said selected, calculated number of LEDs.

13. Apparatus according to claim 12, wherein said processor changes said selected, calculated number of LEDs to form a different spatial distribution pattern of said calculated number of LEDs within each of a plurality of time intervals.

14. Apparatus according to claim 12 or 13 further comprising:
means for retrieving a recorded incoherent sequence and said processor selecting said calculated number of LEDs according to said recorded incoherent sequence.

15. Apparatus according to claim 12 or 13 further comprising:
a synthesiser for synthesising an incoherent sequence and said processor selecting said calculated number of LEDs according to said recorded incoherent sequence.

16. Apparatus according to any one of claims 12 to 15, wherein said plurality of LEDs are arranged in a one-dimensional linear array of LED chains, each LED chain comprising at least one LED.

17. Apparatus according to any one of claims 12 to 15, wherein said plurality of LEDs are arranged in a two-dimensional array of LED chains, each LED chain comprising at least one LED.
